(19) United States
(12) Patent Application Publication
(10) Pub. No.: US 2026/0260272 A1
(43) Pub. Date: Sep. 3, 2026

(54) DEVICE AND METHOD FOR ASSISTING OVERSEAS PROVISION OF EC AND PROGRAM THEREFOR

(71) Applicant: ZIG-ZAG, INC., Tokyo (JP)

(72) Inventors: Satoru SUZUKI, Tokyo (JP); Takayuki IMANISHI, Tokyo (JP)

(21) Appl. No.: 19/122,928

(22) PCT Filed: Oct. 20, 2023
(86) PCT No.: PCT/JP2023/038109

§ 371 Date: Apr. 21, 2025

(30) Foreign Application Priority Data
Oct. 20, 2022 (JP) 2022-168149

(51) Int. Cl. G06Q 30/0601

(52) U.S. Cl. CPC G06Q 30/0601

(57) ABSTRACT

In supporting provision of EC abroad, additional functions provided to a user viewing an EC site are easily enabled to be added. Upon its execution on the user terminal 100 (S601), a module adapted to the EC site provided by the first server 110 can insert a tag into source code of a product page (S602). When the tag is loaded by a web browser of the user terminal 100, a request for an additional module is transmitted to the fourth server 140 associated with the tag (S603). Then, by the received additional module being executed on the user terminal 100 (S604), the additional function required by the EC site is provided to the user of the user terminal 100.

### TECHNICAL FIELD

The present invention relates to an apparatus, a method, and a program therefor for supporting provision of EC abroad.

### BACKGROUND ART

In recent years, the spread of the Internet and further the rapid spread of smartphones have progressed, and various information is now available borderlessly across national borders. There are various types of websites where information can be obtained, and access from abroad to a website (EC site) that provides electronic commerce (EC) is also on an increasing trend. Depending on the EC site, there are cases where a fixed percentage of the number of accesses flows in from abroad even if the site does not support foreign languages.

Even if there is such access from abroad, in the case of an EC site, unlike a website aimed at transmitting information, its purpose cannot be achieved unless payment and delivery are also completed. Sales across national borders are not easy because they often require significant system modification, and an invention that can make purchasing from abroad easier and promote cross-border EC has been disclosed by the applicant (see Patent Document 1).

### PRIOR ART

### Patent Documents

Patent Document 1: International Publication WO2019/035368

### SUMMARY OF THE INVENTION

### Technical Problem

The invention identifies the country of location of the access source of a user terminal of a user who has viewed an EC site, and, according to the identification result, causes a module adapted to the EC site to be executed on the user terminal, thereby making it easy to purchase a product of the EC site from abroad without requiring a significant modification of the EC site. A service applying the invention has already been introduced to over 2000 EC sites.

Although an effective service for supporting cross-border EC exists in this way, the convenience that each EC site further wants to provide to visitors differs, and the inventors have found that there is room to meet this demand by improving the above module.

The present invention has been made in view of such a point, and its objective is to enable easy addition of an additional function provided to a user who views an EC site, in an apparatus, a method, or a program therefor for supporting provision of EC abroad.

### Solution to the Problem

The first aspect of the present invention is a method for supporting provision of EC abroad, comprising steps of: receiving, by a support server, a request for a module for supporting purchase of a product sold on the first web page from abroad, from a user terminal that has accessed a first web page of an EC site; identifying, by the support server, the country of location of the access source of the user terminal to determine whether or not delivery to the country of location is possible; and transmitting, by the support server, a module adapted to the EC site to the user terminal when a result of the determination is possible, wherein the module inserts a tag into source code of the first web page upon its execution on the user terminal.

A second aspect of the present invention is a method for supporting provision of EC abroad, comprising steps of: receiving, by a support server, a request for a module for supporting purchase of a product sold on the first web page from abroad, from a user terminal that has accessed a first web page of an EC site; determining, by the support server, whether or not the product is deliverable abroad; and transmitting, by the support server, a module adapted to the EC site to the user terminal when a result of the determination is possible, wherein the module inserts a tag into source code of the first web page upon its execution on the user terminal.

A third aspect of the present invention is a method for supporting provision of EC abroad, comprising steps of: receiving, by a support server, a transmission request for a module for supporting purchase of a product sold on the first web page from abroad, from a user terminal that has accessed a first web page of an EC site; identifying, by the support server, the country of location of the access source of the user terminal to transmit the country of location to the user terminal; and transmitting, by the support server, a module adapted to the EC site to the user terminal, wherein the module inserts a tag into source code of the first web page upon its execution on the user terminal when delivery to the country is possible.

A fourth aspect of the present invention is a method for supporting provision of EC abroad, comprising steps of: receiving, by a support server, a transmission request for a module for supporting purchase of a product sold on the first web page from abroad, from a user terminal that has accessed a first web page of an EC site; and transmitting, by the support server, a module adapted to the EC site to the user terminal, wherein the module inserts a tag into source code of the first web page upon its execution on the user terminal when the product is deliverable abroad.

A fifth aspect of the present invention is the method according to any one of the first to fourth aspects, wherein the module further inserts the tag into the source code of the first web page when a predetermined tag insertion condition defined within the module is satisfied.

A sixth aspect of the present invention is the method according to any one of the first to fourth aspects, wherein the module, when an indication of intention to purchase the product has been made, transmits purchase information for purchasing the product to a payment server different from a web server providing the EC site.

A seventh aspect of the present invention is the method according to the sixth aspect, wherein the support server is different from the payment server.

An eighth aspect of the present invention is the method according to any one of the first to fourth aspects, wherein the tag is a translation tag for adding a translation function to the first web page.

A ninth aspect of the present invention is the method according to the eighth aspect, wherein the module further inserts the tag into the source code of the first web page when the product has not been excluded as being undeliverable.

A tenth aspect of the present invention is the method according to any one of the first to fourth aspects, wherein the tag is a chat tag for adding a chat function to the first web page.

An eleventh aspect of the present invention is the method according to any one of the first to fourth aspects, wherein the tag is a tag for changing an input screen displayed by the module adapted to the EC site.

A twelfth aspect of the present invention is the method according to any one of the first to fourth aspects, wherein the tag is a tag for enabling addition of an additional product or an additional service as a contract target on the web page.

A thirteenth aspect of the present invention is a program for causing a support server to execute a method for supporting provision of EC abroad, the method comprising steps of: receiving, from a user terminal that has accessed a first web page of an EC site, a request for a module for supporting purchase of a product sold on the first web page from abroad; identifying the country of location of the access source of the user terminal to determine whether or not delivery to the country of location is possible; and transmitting a module adapted to the EC site to the user terminal when a result of the determination is possible, wherein the module inserts a tag into source code of the first web page upon its execution on the user terminal.

A fourteenth aspect of the present invention is a program for causing a support server to execute a method for supporting provision of EC abroad, the method comprising steps of: receiving, from a user terminal that has accessed a first web page of an EC site, a request for a module for supporting purchase of a product sold on the first web page from abroad; determining whether or not the product is deliverable abroad; and transmitting a module adapted to the EC site to the user terminal when a result of the determination is possible, wherein the module inserts a tag into source code of the first web page upon its execution on the user terminal.

A fifteenth aspect of the present invention is a program for causing a support server to execute a method for supporting provision of EC abroad, the method comprising steps of: receiving, from a user terminal that has accessed a first web page of an EC site, a transmission request for a module for supporting purchase of a product sold on the first web page from abroad; identifying the country of location of the access source of the user terminal to transmit the country of location to the user terminal; and transmitting a module adapted to the EC site to the user terminal, wherein the module inserts a tag into source code of the first web page upon its execution on the user terminal when delivery to the country of location is possible.

A sixteenth aspect of the present invention is a program for causing a support server to execute a method for supporting provision of EC abroad, the method comprising steps of: receiving, from a user terminal that has accessed a first web page of an EC site, a transmission request for a module for supporting purchase of a product sold on the first web page from abroad; and transmitting a module adapted to the EC site to the user terminal, wherein the module inserts a tag into source code of the first web page upon its execution on the user terminal when the product is deliverable abroad.

A seventeenth aspect of the present invention is a support server for supporting provision of EC abroad, configured to: receive a request for a module for supporting purchase of a product sold on the first web page from abroad, from a user terminal that has accessed a first web page of an EC site; identify the country of location of the access source of the user terminal to determine whether or not delivery to the country of location is possible; and transmit a module adapted to the EC site to the user terminal when a result of the determination is possible, wherein the module inserts a tag into source code of the first web page upon its execution on the user terminal.

An eighteenth aspect of the present invention is a support server for supporting provision of EC abroad, configured to: receive a request for a module for supporting purchase of a product sold on the first web page from abroad, from a user terminal that has accessed a first web page of an EC site; determine whether or not the product is deliverable abroad; and transmit a module adapted to the EC site to the user terminal when a result of the determination is possible, wherein the module inserts a tag into source code of the first web page upon its execution on the user terminal.

A nineteenth aspect of the present invention is a support server for supporting provision of EC abroad, configured to: receive a transmission request for a module for supporting purchase of a product sold on the first web page from abroad, from a user terminal that has accessed a first web page of an EC site; identify the country of location of the access source of the user terminal, and transmit the country and a module adapted to the EC site to the user terminal, wherein the module inserts a tag into source code of the first web page upon its execution on the user terminal when delivery to the country of location is possible.

A twentieth aspect of the present invention is a support server for supporting provision of EC abroad, configured to: receive a transmission request for a module for supporting purchase of a product sold on the first web page from abroad, from a user terminal that has accessed a first web page of an EC site; and transmit a module adapted to the EC site to the user terminal, wherein the module inserts a tag into source code of the first web page upon its execution on the user terminal when the product is deliverable abroad.

According to one aspect of the present invention, in response to a user terminal accessing a web page of an EC site, a module adapted to the EC site is executed on the user terminal to insert a tag into the source code of the web page, thereby easily providing an additional function desired by the EC site to a user using the user terminal.

### BRIEF DESCRIPTION OF THE DRAWINGS

FIG. 1 is a diagram showing a system for supporting provision of EC abroad according to an embodiment of the present invention.

FIG. 2 is a diagram showing the transmission and reception of information between apparatuses according to an embodiment of the present invention.

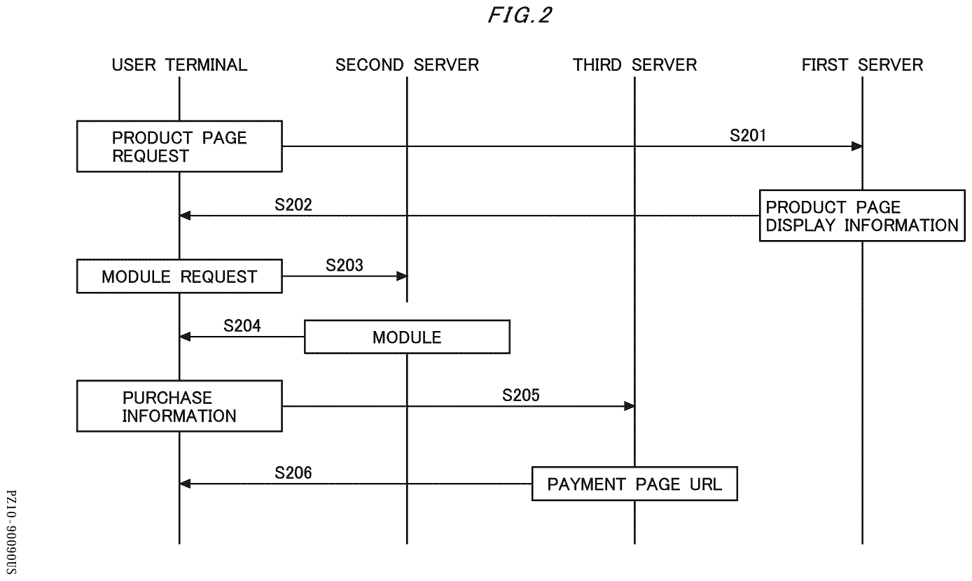

FIG. 3 is a diagram showing a display element for supporting provision of EC abroad according to an embodiment of the present invention.

FIG. 4 is a diagram showing an example of a screen displayed when a part of the display element of FIG. 3 is clicked or tapped.

FIG. 5 is a diagram showing an example of a screen including details of a product to be purchased displayed when a shopping cart icon of FIG. 3 is clicked or tapped.

FIG. 6 is a diagram showing a flow of tag insertion according to an embodiment of the present invention.

### DESCRIPTION OF THE EMBODIMENTS

Hereinafter, embodiments of the present invention will be described in detail with reference to the drawings.

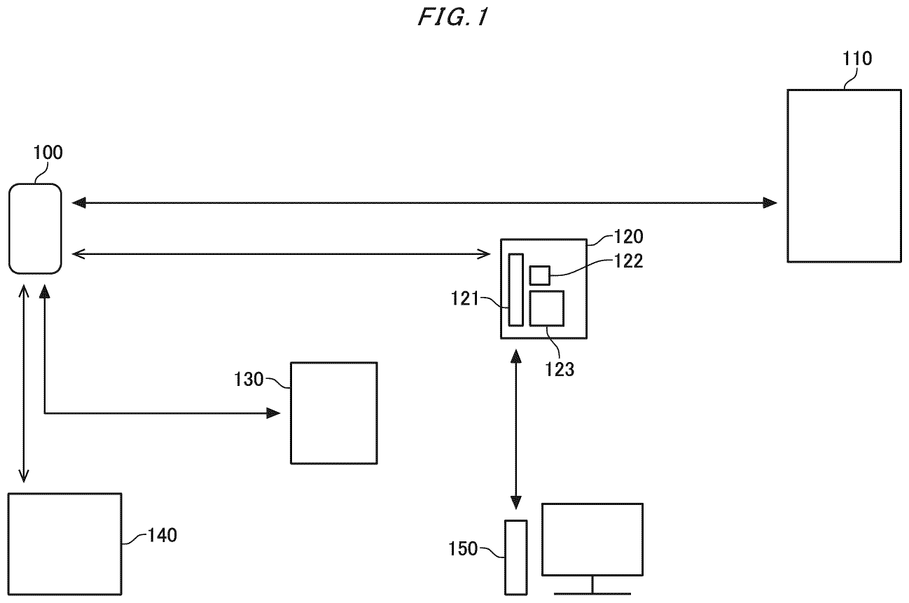

FIG. 1 shows a system for supporting provision of EC abroad according to an embodiment of the present invention. In the system, a user terminal 100 used by a user requests a first server 110 that provides an EC site for a product page for a product sold on the EC site (S201). In response to the request, the first server 110 transmits product page display information for displaying the product page to the user terminal 100 (S202). The product page display information may be, for example, a file in HTML format. Since the first server 110 enables viewing of a web page, it is sometimes called a web server.

When the product page display information is loaded by a web browser operating on the user terminal 100, a module for supporting the purchase of the product sold on the product page is requested to a second server 120 different from the first server 110 (S203). The second server 120 is sometimes called a support server. The module is a module adapted to the EC site, and is for example, a file described in Javascript (registered trademark) (hereinafter also referred to as “JS”). For example, since the format of the product page display information may differ for each EC site, by setting which information is described in which part of the product page display information for each EC site, the module can be made to perform an operation adapted to the content of the product page. Not limited to such settings, the module can be adapted to the EC site by making it a module according to one or more settings for each EC site.

The request for the module is transmitted when the product page is loaded by describing a tag as follows in the source code of the product page.
<script type=“text/javascript” src=“https://checkout-api.xxxx.jp/v1/script? token=xyz”></script>

Here, “checkout-api.xxxx.jp” indicates the second server 120, and “token=xyz” indicates that the identifier for identifying the EC site or its product page provided by the first server 110 is “xyz”.

The second server 120 identifies the country of location of the access source of the user terminal 100, determines whether or not the module can be loaded on the user terminal 100, and transmits the module to the user terminal 100 when a result of the determination is possible (S204).

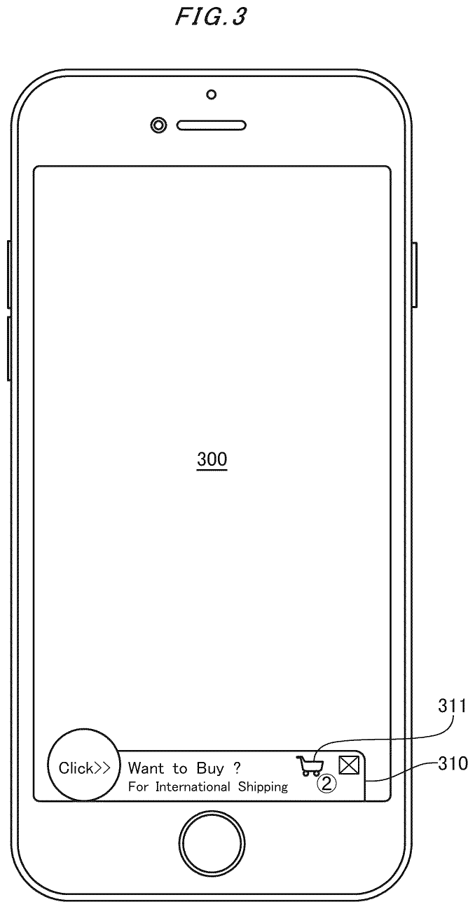

When the module is loaded on the user terminal 100, a display element 310 for supporting the purchase of the product from abroad can be displayed on the display screen of the user terminal 100, along with a product page 300 (details of the content to be displayed are omitted) as shown in FIG. 3. The display element 310 can be superimposed on the product page 300, and more preferably, it can be displayed at the bottom of the web browser operating on the user terminal 100, fixed to the bottom if necessary. The display element 310 can be superimposed on the product page, for example, as a floating banner or a pop-up window.

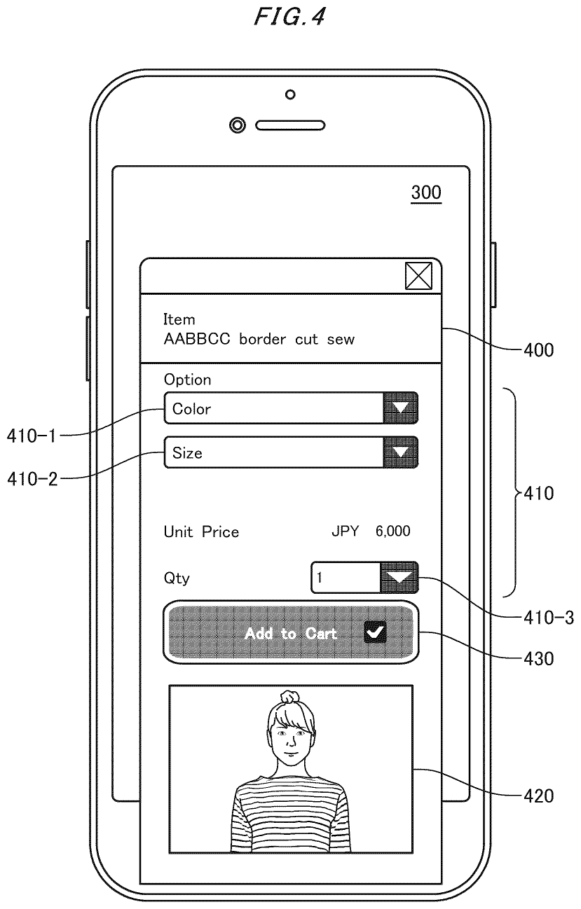

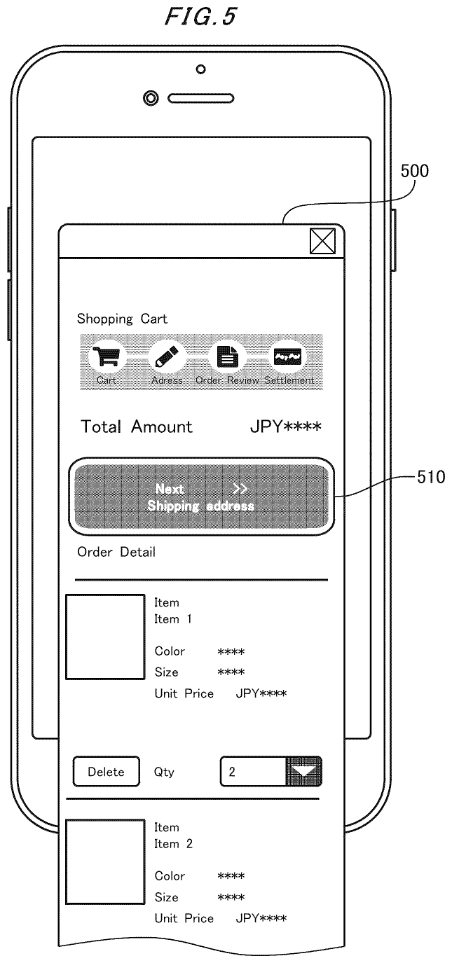

FIG. 4 shows an example of a screen displayed when a part of the display element of FIG. 3 is clicked or tapped. A screen 400 can be a pop-up window, and may be displayed as a modal window that restricts operations on a parent window or a parent screen until a response is obtained from the user. In FIG. 4, the window 400 is shown exceeding the display screen of the user terminal 100, since it includes the area displayed when scrolled. The same applies to FIG. 5 mentioned below.

On the screen 400, input fields 410 for purchasing the product displayed on the product page 300 can be displayed. The input fields 410 may include at least one of a color input field 410-1 and a size input field 410-2. The color input field 410-1 and the size input field 410-2 can be in the form of a pull-down menu. The input fields 410 may include a quantity input field 410-3 for the product. Considering that the purchaser of the product is an overseas user, the input fields 410 are preferably displayed together with an image 420 of the product, in order to visually convey that the user is proceeding with the purchase procedure for the intended product. In addition to these, input fields for other items necessary to specify the SKU required for each EC site may be provided. When the user inputs purchase information necessary for purchasing the product and a “Add to Cart” button 430 is clicked or tapped, the purchase information is stored in the user terminal 100. At this time, a display indicating that a product scheduled for purchase exists in the display element 310 may be made. In the example of FIG. 3, the number of products scheduled for purchase is displayed near a shopping cart icon 311.

Although an example in which the screen 400 is displayed in response to a part of the display element 310 being clicked or tapped has been described here, it is also possible to generate the module so that the screen 400 is displayed in response to a part of the product page 300 being clicked or tapped. Also, although an example in which purchase information for purchasing the product is input using the input screen 400 displayed by execution of a command included in the module has been described, it is also possible to generate the module to read the purchase information, such as the number and quantity, stored in the user terminal 100, which is input directly using one or more input fields and an “Add to Cart” button that the product page 300 has.

When the user inputs purchase information for purchasing the product displayed on the product page on the user terminal 100, using the display element 310 as necessary as described above, and an indication of intention to purchase the product is made, the purchase information is transmitted to a third server 130 different from the first server 110 providing the EC site (S205). The purchase information can be stored in the third server 130 or a storage medium or storage device accessible therefrom, along with an order ID for each order. The order ID may be included in the purchase information, or may be generated by the third server 130 for the received purchase information.

For example, input of the indication of intention can be received by displaying the details of the product scheduled for purchase as shown in FIG. 5 in response to the shopping cart icon 311 in the display element 310 being clicked or tapped, then receiving input of delivery destination information, and subsequently causing a “Confirm” button (not shown) to be clicked or tapped, but the procedure is not limited to this, and the delivery destination information may be input after transitioning to a payment page described later. Also, input of the indication of intention to purchase the product may be enabled in response to a shopping cart icon (not shown) in the product page 300 being clicked or tapped.

The third server 130 can transmit the URL of the payment page specified by the order ID or a key corresponding thereto to the user terminal 100 as a transfer destination or transition destination (S606). The web browser of the user terminal 100 transitions to the payment page in response to the reception of the URL. Since the third server 130 is a server for proceeding with payment, it is sometimes referred to as a payment server.

The second server 120 and the third server 130 are operated by a business operator who performs purchase agency for the products of the EC site, and the business operator purchases one or more products determined by the purchase information received by the third server 130 in the country of location of the operator of the EC site or a country where the operator can deliver, and receives them at its own delivery destination address. After receiving the one or more products, the business operator inspects and packs them, and delivers them to the user of the user terminal 100.

The module adapted to the EC site provided by the first server 110 can insert a tag into the source code of the product page or other web page of the EC site by being executed on the user terminal 100 (S601) (S602). When the tag is loaded by the web browser of the user terminal 100, a request for an additional module is transmitted to a fourth server 140 associated with the tag (S603). Then, by the received additional module being executed on the user terminal 100 (S604), the additional function required by the EC site is provided to the user of the user terminal 100. The module adapted to the EC site may insert the tag when a predetermined tag insertion condition is satisfied. This may include inserting the tag when a predetermined tag non-insertion condition is not satisfied. Examples of the additional module will be described later.

The tag insertion condition can be input on a setting screen displayed by the web browser of the administrator terminal 150, for example, by transmitting tag insertion condition setting screen display information from the second server 120 to the administrator terminal 150 used by the administrator of the EC site, for example, in HTML format.

The second server 120 described above comprises a communication unit 121 such as a communication interface, a processing unit 122 such as a processor or CPU, and a storage unit 123 including a storage device or storage medium such as memory or a hard disk, and can be configured by executing a program for performing each process or operation in the processing unit 122. The second server 120 may include one or more apparatuses, computers, or servers. Also, the program may include one or more programs, and can be recorded on a computer-readable storage medium to be a non-transitory program product. The program can be stored in the storage unit 123 or a storage device or storage medium such as a database accessible from the second server 120 via an IP network, and instructions included in the program can be executed on at least one processor of the processing unit 122. Data described herein as being stored in the storage unit 123 may be stored in the above storage device or storage medium, and vice versa. Although not shown, the first server 110, the third server 130, and the fourth server 140 can have a configuration similar to that of the second server 120. Also, the second server 120 and the third server 130 are shown as separate servers in FIG. 1, but they may be the same server.

Also, although the operation of the second server 120, the operation of the third server 130, the purchase of one or more products determined by the purchase information, and the delivery of the purchased products are all described as being performed by the purchase agency business operator, a person entrusted by the purchase agency business operator may play each role.

Also, although the case where the second server 120 identifies the country of location of the access source of the user terminal 100 and determines whether or not the module can be loaded on the user terminal 100 has been described, the country of location of the access source of the user terminal 100 identified by the second server 120 may be transmitted to the user terminal 100, and the user terminal 100 may determine that the product sold on the web page accessed by the user terminal 100 is deliverable to the country of location, and in that case, the module may be executed. Here, the identification of the country of location includes identifying the name of the country of location, in addition to identifying whether it is domestic or abroad.

Which country is deliverable can be set in the second server 120 on an EC site unit basis or on a product unit basis sold on the EC site, and it is synonymous to specify the deliverable country by setting the undeliverable country. One or more deliverable countries may be set on an EC site unit basis, and even within the one or more countries, products that are individually undeliverable may be set on a product unit basis. Note that the expression deliverable or undeliverable is synonymous with purchasable or unpurchasable for the purchase agency business operator, since if a product is purchased, it is delivered to the client of the purchase agency.

Also, it is conceivable that the module adapted to the EC site is executed on the user terminal 100 when the product sold on the web page accessed by the user is deliverable abroad, instead of when the purchase agency business operator is deliverable to the country identified as the country of location of the access source of the user.

### Translation Tag

It may be preferable to translate the web page viewed by a user who visited the EC site with some interest into a language that the user can understand. For example, by inserting a tag as follows into the web page, a translation module “trans.js” described in JS is executed on the user terminal 100, and the web page is translated. Here, “https://xxx.trans.com” indicates a fourth server 140 which is a translation server that provides a translation service, and “id=165” indicates that the identifier for identifying the EC site provided by the first server 110 is “165”. The translation module may further request and acquire another module within itself.
<script type=“text/javascript” charset=“UTF-8”src=“https://xxx.trans.com/trans.js?id=165”></script>

Since translating all web pages of an EC site increases the usage fee for the translation service, it is desirable to insert a translation tag for executing a translation script only on pages with high cost-effectiveness for translation. More specifically, it is preferable to suppress the translation cost for undeliverable access that does not lead to sales, while providing the additional function to the user, by executing the module adapted to the EC site on the user terminal 100 when delivery to the country of location of the access source of the user terminal 100 identified by the second server 120 is possible, and inserting the translation tag into the source code of the product page. Also, if the product sold on the product page is excluded as being undeliverable to the country of location or abroad, translating it will not lead to sales, so it is preferable to insert the translation tag when delivery to the country of location is possible and further the product has not been excluded as being undeliverable.

In addition to executing the module adapted to the EC site on the user terminal 100 when delivery to the country of location of the access source of the user terminal 100 identified by the second server 120 is possible, the translation tag may be inserted when a predetermined tag insertion condition is satisfied. As an example, an additional function may be provided to pages with higher sales potential to the user of the user terminal 100 by inserting the translation tag for the products with a large number of accesses by other users from the same country as the country identified as the country of location of the access source of the user terminal 100, or the products with a large number of accesses by users from the target country of the EC site provided by the first server 110 (for example, a user who accessed from Japan if the EC site is operated in Japan).

### Chat Tag

It may be preferable to increase the willingness to purchase by providing customer service in response to questions from a user who visited the EC site. For example, similar to the translation tag, by inserting a tag into the web page, a chat module described in JS is executed on the user terminal 100, and a chat window for responding to questions about the product sold on the web page is displayed superimposed on the web page.

Since adding a chat window to all web pages of an EC site increases the usage fee for the chat service, it is desirable, similar to the translation tag, to insert the chat tag only on pages with high cost-effectiveness for customer service. Regarding the chat tag, since it is a communication channel with the user who visited the EC site, it may be preferable to insert it even if the product sold on the web page accessed by the user is individually excluded as undeliverable from deliverable products, and even if delivery to the country of location of the access source of the user is not possible.

### Coupon Tag

It may be preferable to increase the willingness to purchase by giving a coupon to a user who visited the EC site. However, the EC site intends to give a coupon to a user who accessed from domestically or from a predetermined country, and the coupon may be unintentionally displayed to a user who is not eligible for the coupon among users who became able to purchase the product by the module according to the present invention. Therefore, conversely, when delivery to the country of location of the access source of the user is possible, the module for supporting purchase from abroad is transmitted to the user terminal 100, but a tag for requesting a coupon granting module may not be inserted into the web page accessed by the user by the module, or the coupon granting module associated with the tag may not be executed.

### Insurance Tag

Among users who purchase a product on an EC site, some desire an insurance service in addition to the warranty provided by the manufacturer who sells the product. This is also the case for users who accessed the web page selling the product from abroad or a predetermined country. Therefore, an insurance service is enabled to be added on the input screen for inputting purchase information displayed by the module adapted to the EC site. Specifically, as an example, by executing the module adapted to the EC site, a tag is inserted into the source code of the web page, and by an insurance module associated with the tag being executed on the user terminal 100, the module adapted to the EC site can be modified to change the input screen as described above.

Although the insurance service has been used as an example here, more generally, the additional function required by the EC site can be provided to the user of the user terminal 100 by modifying the module adapted to the EC site by the additional module associated with the tag inserted into the source code of the web page.

Instead of modifying the module adapted to the EC site to change the input screen displayed by the module, the source code of the product page accessed by the user may be modified to enable addition of the insurance service or other additional service or additional product on the product page. For example, the insurance service is enabled to be added as an intended service on the product page, and when the “Add to Cart” button of the product page is pressed, the purchase information stored in the user terminal 110 includes the insurance service. Also, the source code of the web page for confirming the product to be purchased may be modified to enable addition of the insurance service or other additional service or additional product as an intended service on the web page.

It should be noted that if there is no description of “only,” such as “based only on,” “in response only to,” or “in the case only of,” in the above-described embodiments, it is assumed in the present specification that additional information may also be considered. Also, for example, it should be noted that the description “perform b in the case of a” does not necessarily mean “always perform b in the case of a” or “perform b immediately after a,” unless explicitly stated. Also, the description “each component a of A” does not necessarily mean that A comprises a plurality of components, and includes the case where the component is singular.

In addition, as a caveat, even if there are aspects of a method, a program, a terminal, an apparatus, a server or a system (hereinafter referred to as “method, etc.”) that perform operations different from those described herein, each aspect of the invention is an invention directed to one of the operations described herein, and the existence of an operation different from those described herein does not mean that the method, etc. is outside the scope of each aspect of the invention.

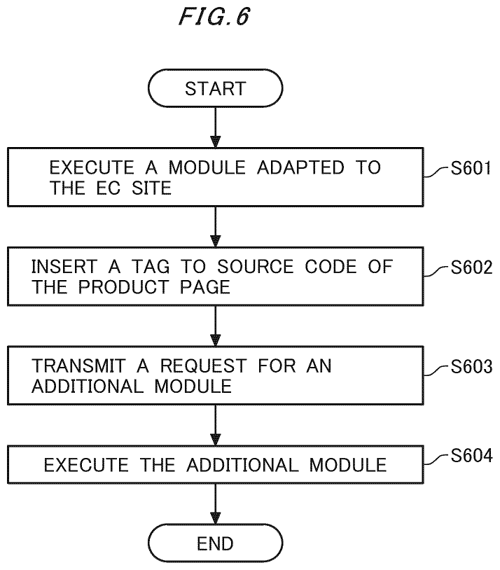

Furthermore, “START” and “END” shown in FIG. 6 are merely examples, and do not mean that the method according to the present embodiment must start with the illustrated procedure and must end with the illustrated procedure.

### DESCRIPTION OF REFERENCE NUMERALS

100 User terminal
110 First server
120 Second server
121 Communication unit
122 Processing unit
123 Storage unit
130 Third server
140 Fourth server
150 Administrator terminal
300 Product page
310 Display element
311 Shopping cart icon
400 Input screen
410 Input field
410-1 Color input field
410-2 Size input field
410-3 Quantity input field
420 Product image
430 “Add to Cart” button
500 Confirmation screen
510 Proceed button

1. A method for supporting provision of EC abroad, comprising steps of:
receiving, by a support server, a request from a user terminal that has accessed a first web page of an EC site for transmission of a module for supporting purchase of a product sold on the first web page from abroad;
identifying, by the support server, a country in which the user terminal is located to transmit the country to the user terminal; and
transmitting, by the support server, a module adapted to the EC site to the user terminal,
wherein the module, when delivery to the country is possible, inserts a tag into source code of the first web page upon its execution on the user terminal.

2. The method according to claim 1, wherein the module inserts the tag into the source code of the first web page when a predetermined tag insertion condition defined within the module is satisfied.

3. The method according to claim 1, wherein the module, when a purchase intention for the product has been indicated, transmits purchase information for purchasing the product to a payment server different from a web server providing the EC site.

4. The method according to claim 3, wherein the support server is different from the payment server.

5. The method according to claim 1, wherein the tag is a translation tag for adding a translation function to the first web page.

6. The method according to claim 5, wherein the module inserts the tag into the source code of the first web page when the product has not been excluded as being undeliverable.

7. The method according to claim 1, wherein the tag is a chat tag for adding a chat function to the first web page.

8. The method according to claim 1, wherein the tag is a tag for changing an input screen displayed by the module adapted to the EC site.

9. A program for causing a support server to execute a method for supporting provision of EC abroad, the method comprising:
receiving, from a user terminal that has accessed a first web page of an EC site, a request for transmission of a module for supporting purchase of a product sold on the first web page from abroad;
identifying a country in which the user terminal is located to the country to the user terminal; and
transmitting, to the user terminal, a module adapted to the EC site,
wherein the module, when delivery to the country is possible, inserts a tag into source code of the first web page upon its execution on the user terminal.

10. A support server for supporting provision of EC abroad, configured to:
receive, from a user terminal that has accessed a first web page of an EC site, a request for transmission of a module for supporting purchase of a product sold on the first web page from abroad;
identify a country in which the user terminal is located, and transmit the country and a module adapted to the EC site to the user terminal;
wherein the module, when delivery to the country is possible, inserts a tag into source code of the first web page upon its execution on the user terminal.
